(19) United States
(12) Patent Application Publication
(10) Pub. No.: US 2001/0016639 A1
(43) Pub. Date: Aug. 23, 2001

(54) Article formed from propylene diene copolymers

(76) Inventors: Pawan Kumar Agarwal, Houston, TX (US); Weiqing Weng, Houston, TX (US); Aspy Keki Mehta, Humble, TX (US); Armenag Hagop Dekmezian, Kingwood, TX (US); Christopher Ross Davey, Houston, TX (US); Charlie Y. Lin, Houston, TX (US); Michael Chia-Chao Chen, Houston, TX (US); Galen Charles Richeson, Kingwood, TX (US)

Correspondence Address: ExxonMobil Chemical Company, P. O. Box 2149, Baytown, TX, 77522, US

(21) Appl. No.: 09/734,100

(22) Filed: Dec. 11, 2000

Related U.S. Application Data
(63) Continuation-in-part of application No. 09/459,035, filed on Dec. 10, 1999.

(51) Int. Cl. C08F 10/14

(52) U.S. Cl. 526/336; 526/348.2; 526/348.3; 526/348.5; 526/348.6

(57) ABSTRACT

The co-polymerization reaction of one or more olefin monomers, such as propylene, with α,ω-diene units and the resulting copolymers are provided. More specifically, the copolymer may have from 90 to 99.999 weight percent of olefins and from 0.001 to 2.000 weight percent of α,ω-dienes. The copolymer may have a weight average molecular weight in the range from 50,000 to 2,000,000, a crystallization temperature in the range from 115° C. to 135° C. and a melt flow rate in the range from 0.1 dg/min to 100 dg/min. These copolymers may be employed in a wide variety of applications, the articles of which include, for example, films, fibers, such as spunbonded and meltblown fibers, fabrics, such as nonwoven fabrics, and molded articles. The copolymer may further include at least two crystalline populations. Desirably, the melting point range of one of the crystalline populations is distinguishable from the melting point range of another crystalline population by a temperature range of from 1° C. to 8° C. More desirably, one of the crystalline populations has a melting point in the range from 152° C. to 158° C. and another crystalline population has a melting point in the range from 142° C. to 148° C.

### FIELD OF INVENTION

The present invention relates to propylene copolymers. More particularly the invention relates to copolymers formed from the copolymerization of propylene and diene monomers.

### BACKGROUND OF THE INVENTION

Polypropylene is an inexpensive thermoplastic polymer employed in a wide variety of applications, the articles of which include, for example, films, fibers, such as spunbonded and meltblown fibers, fabrics, such as nonwoven fabrics, and molded articles. The selection of polypropylene for any one particular application depends, in part, on the physical and mechanical properties of the polypropylene polymer candidate as well as the article fabrication mode or manufacturing process. Examples of physical properties include density, molecular weight, molecular weight distribution, melting temperature and crystallization temperature. Examples of mechanical properties include heat distortion temperature (HDT) and Flexual Modulus values. Examples of factors relevant to the processing environment include the cycle time, melt flow rate (MFR), bubble stability, sag resistance, melt strength and shear/elongational viscosity.

In some instances articles formed from polypropylene, for example, via an injection molding process, may require a high degree of structural rigidity. Additionally, for such articles to be economically manufactured, the fabrication mode must be capable of producing the article at a selected rate, also referred to as “cycle time”. The cycle time for injection molding may generally be described as the duration from the introduction of molten polymer into the mold to the release of the molded article from the mold. Thus, cycle time is a function of the viscosity of the molten polymer. While it is understood that many other variables may be relevant and require consideration before selecting a polymer for a particular application, for purposes of this background discussion, only the mechanical property associated with rigidity and physical property associated with viscosity behavior are discussed.

With regard to the requirement that the polymer article possess a high degree of structural rigidity, the modulus value may be directly correlated with this mechanical property of a polymer. For achieving a high structural rigidity in a molded article, polymers exhibiting higher modulus values are more desirable.

With regard to the cycle time, in addition to the viscosity behavior, the crystallization temperature of a polymer is a physical property that may be directly correlated to cycle time. Generally, the crystallization temperature is the pivotal temperature at which the molten liquid polymer hardens. This hardening is due, in part, to the formation of crystalline structures within the polymer. It follows that as the molten polymer cools in the mold, molten polymers having higher crystallization temperatures (temperatures closer to the melting temperature of the polymer) will form crystalline structures sooner than polymers having lower crystallization temperatures (temperatures further from the melting temperature of the polymer). As such, shorter cycle times may be achieved by using polymers with higher crystallization temperatures.

As the criteria for polymer applications and articles formed therefrom continue to evolve, there remains a need to continually modify and improve both the physical, mechanical and rheological properties of polymers, and in particularly polypropylene polymers, to meet these evolving criteria.

### SUMMARY OF THE INVENTION

The present invention involves the reaction, and particularly a co-polymerization reaction of olefins monomers, wherein one such olefin monomer is desirably propylene, with an (α,ω-diene and the olefin/α,ω-diene copolymers resulting therefrom. Desirably, the present invention involves a co-polymerization reaction of olefin monomers, wherein the olefin monomers co-polymerized include propylene and ethylene monomers with an α,ω-diene and the copolymer resulting therefrom. These copolymers may be employed in a wide variety of applications, the articles of which include, for example, films, fibers, such as spundonbed and meltblown fibers, fabrics, such as nonwoven fabrics, and molded articles. More particularly, these articles include, for example, cast films, oriented films, injection molded articles, blow molded articles, foamed articles, foam laminates and thermoformed articles.

The present invention includes a copolymer having from 90 to 99.999 weight percent olefin units, and from 0.001 to 2.000 weight percent α,ω-diene units. The copolymer may have a weight average molecular weight in the range from 50,000 to 2,000,000, a crystallization temperature in the range from 115° C. to 135° C. and a melt flow rate in the range from 0.1 dg/min to 100 dg/min. The copolymer may further include at least two crystalline populations. Desirably, the melting point range of one of the crystalline populations is distinguishable from the melting point range of another crystalline population by a temperature range of from 1° C. to 8° C. More desirably, one of the crystalline populations has a melting point in the range from 152° C. to 158° C. and another crystalline population has a melting point in the range from 142° C. to 148° C.

In another embodiment, the copolymer includes from 90 to 99.999 weight percent of propylene units, from 0.00 to 8 weight percent of olefin units other than propylene units and from 0.001 to 2.000 weight percent α,ω-diene units. The copolymer may have a weight average molecular weight in the range from 50,000 to 2,000,000, a crystallization temperature in the range from 115° C. to 135° C. and a melt flow rate in the range from 0.1 dg/min to 100 dg/min. The olefin may be selected from the group which includes C₂-C₁₀ α-olefins, diolefins and mixtures thereof More specifically, the olefin may include ethylene, butene-1, pentene-1, hexene-1, heptene-1, 4-methyl-1-pentene, 3-methyl-1-pentene, 4-methyl-1-hexene, 5-methyl-1-hexene, 1-octene, 1-decene, 1-undecene, and 1-dodecene. The copolymer may further include at least two crystalline populations. Desirably, the melting point range of one of the crystalline populations is distinguishable from the melting point range of another crystalline population by a temperature range of from 1° C. to 8° C. More desirably, one of the crystalline populations has a melting point in the range from 152° C. to 158° C. and another crystalline population has a melting point in the range from 142° C. to 148° C.

### BRIEF DESCRIPTION OF THE DRAWINGS

FIG. 1 is a graph illustrating the melting curves of copolymer formed in Examples 5, 6 and 8 and a comparative polymer formed in Example 14.

FIG. 2A is a partial cross-section of a molded specimen formed from the copolymer of Example 1.

FIG. 2B is a partial cross-section of a molded specimen formed from the comparative polymer of Example 14.

FIG. 3 is a graph plotting extensional viscosity values for the polymer formed in Example 4.

### DETAILED DESCRIPTION OF THE INVENTION

Ranges are used throughout the description of the invention to further define the invention. Unless otherwise stated, it will be understood that these ranges include the recited end point value(s) as well as those values defined by and/or between the recited end point value(s).

In the description of the copolymer, and particularly when describing the constituents of the copolymer, in some instances, monomer terminology may be used. For example, terms such as “olefin”, “propylene”, “α,ω-diene”, “ethylene” and other α-olefins, may be used. It will be understood that when such monomer terminology is used to describe the constituents of the copolymer, such monomer terminology shall mean the polymerized units of such monomers present in the copolymer.

The copolymer includes a co-polymerization reaction product, and desirably a metallocene co-polymerization reaction product, of one or more olefin monomers, wherein one such olefin monomer is propylene and one or more α,ω-diene monomers. Desirably, the copolymer includes a co-polymerization reaction product, and desirably a metallocene co-polymerization reaction product, of two or more olefin monomers, wherein the olefin monomers are α-olefin monomers, and particularly propylene and ethylene monomers, with one or more α,ω-diene monomers.

Generally, the olefin units are present in the copolymer in the range from 90 weight percent (wt %) to 99.99 wt % of the copolymer. The α,ω-diene(s) units are present in the copolymer in the range from 0.001 wt % to 2 wt % of the copolymer. Desirably the α,ω-diene(s) units are present in the range from 0.003 wt % to 1.5 wt % and more desirably in the range from 0.005 wt % to 1.0 wt % of the copolymer.

When two or more different olefin units are present, desirably one of the olefin units are propylene units, which may be present in the copolymer in the range from 90.05 wt % to 99.99 wt % of the copolymer. Of the other olefin units, one of which is desirably ethylene units, may be present in the copolymer in the range from 0.05 wt % to 8 wt %, and desirably in the range from 0.1 wt % to 6 wt % and more desirably in the range from 0.5 wt % to 3 wt % of the copolymer. The α,ω-diene(s) units are present in the copolymer in the range from 0.001 wt % to 2 wt % of the copolymer. Desirably the α,ω-diene(s) are present in the range from 0.005 wt % to 1.5 wt % and more desirably in the range from 0.005 wt % to 1.0 wt % of the copolymer.

Still more desirably, the copolymer includes: propylene units in the range from 90 wt % to 99.99 wt % of the copolymer; C₂ or other α-olefin(s) units in the range from 0.00 wt % to 8 wt %, desirably in the range from 0.05 to 6 wt % and more desirably in the range from 0.5 wt % to 3 wt % of the copolymer; the α,ω-diene(s) units are present in the copolymer in the range from 0.001 wt % to 2 wt %, desirably in the range from 0.005 wt % to 1.5 wt % and more desirably in the range from 0.005 wt % to 1.0 wt % of the copolymer.

The copolymer has a weight average molecular weight in the range from 50,000 to 2,000,000, desirably from 70,000 to 1,000,000 and even more desirably from 100,000 to 750,000. The copolymer has a molecular weight distribution (MWD) in the range from 2 to 15, desirably from 2 to 10 and even more desirably from 2 to 8.

The copolymer has a crystallization temperature in the range from 115° C. to 135° C., and desirably from greater than 115° C. to 130° C., and more desirably from 115° C. to 126° C. The copolymer may further include at least two crystalline populations. Desirably, the melting point range of one of the crystalline populations is distinguishable from the melting point range of another crystalline population by a temperature range of from 1° C. to 8° C. More desirably, one of the crystalline populations has a melting point in the range from 152° C. to 158° C. and another crystalline population has a melting point in the range from 142° C. to 148° C.

The copolymer may have a melt flow rate (MFR) in the range of from 0.1 dg/min to 100 dg/min, desirably from 0.5 dg/min to 50 dg/min, even more desirably from 1.0 dg/min to 35 dg/min. MFR is determined according to ASTM D-1238, condition L (2.16 kg, 230° C.). The melting point of the copolymer may be less than 165° C., and desirably less than 160° C. Upper limits for melting point depend on the specific application but would typically not be higher than 165° C. The hexane extractable level (as measured by 21 CFR 177.1520(d)(3)(i)) of the copolymer may be less than 2.0 wt %, and desirably less than 1.0 wt %.

The copolymer desirably has a ratio of extensional viscosity to linear viscosity of at least 2.5, desirably of at least 3.5 and more desirably of at least 3.5 at strain rates from 0.1 l/second to 1.0 l/second.

The copolymer may include blends, including reactor blends of α-olefins and particularly homopolymers and blends, including reactor blends of polypropylene and particularly metallocene catalyzed polypropylene.

The copolymer may further be described as “branched”. As used herein, the term “branched” means one or more α,ω-diene unit linkages, desirably at the α,ω positions of the α,ω-diene unit, between one or more polymer chains formed by the polymerization of one or more α-olefins.

The copolymer may be blended with other polymers, particularly with other polyolefins. Specific examples of such polyolefins include, but are not limited to ethylene-propylene rubber, ethylene-propylene diene rubber, and ethylene plastomers. Specific examples of commercially available ethylene plastomers include EXACT™ resins products of Exxon Chemical Company and, AFFINITY™ resins and ENGAGE™ resins, products of Dow Chemical Company.

These copolymers may be employed in a wide variety of applications, the articles of which include, for example, films, fibers, such as spundonbed and meltblown fibers, fabrics, such as nonwoven fabrics, and molded articles. More particularly, these articles include, for example, cast films, oriented films, injection molded articles, blow molded articles, foamed articles, foam laminates and thermoformed articles.

### Olefins

Olefins (polymerizable reactants) suitable for use include ethylene, C₂-C₁₀ α-olefins or diolefins. Examples of α-olefins include, for example, propylene, butene-1, pentene-1, hexene-1, heptene-1, 4-methyl-1-pentene, 4-methyl-1-hexene, 5-methyl-1-hexene, 1-octene, 1-decene, 1-undecene, 1-dodecene and the like. In addition, mixtures of these and other α-olefins may also be used, such as, for example, propylene and ethylene as well as monomer combinations from which elastomers are formed. Ethylene, propylene, styrene and butene-1 from which crystallizable polyolefins may be formed are particularly desirable.

### Dienes

Examples of suitable α,ω-dienes include α,ω-dienes that contain at least 7 carbon atoms and have up to about 30 carbon atoms, more suitably are α,ω-dienes that contain from 8 to 12 carbon atoms. Representative examples of such α,ω-dienes include 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and the like. Of these, 1,7-octadiene, and 1,9-decadiene more desirable, particularly desirable is 1,9-decadiene. The diene content can be estimated, for example, by measuring absorbance at 722 cm⁻¹ using infrared spectroscopy.

### Catalyst Composition

Metallocenes: As used herein “metallocene” and “metallocene component” refer generally to compounds represented by the formula CpₘMRₙX_{q} wherein Cp is a cyclopentadienyl ring which may be substituted, or derivative thereof which may be substituted, M is a Group 4, 5, or 6 transition metal, for example titanium, zirconium, hafnium, vanadium, niobium, tantalum, chromium, molybdenum and tungsten, R is a hydrocarbyl group or hydrocarboxy group having from one to 20 carbon atoms, X is a halogen, and m=1-3, n=0-3, q=0-3, and the sum of m+n+q is equal to the oxidation state of the transition metal.

Methods for making and using metallocenes are very well known in the art. For example, metallocenes are detailed in U.S. Pat. Nos. 4,530,914; 4,542,199; 4,769,910; 4,808,561; 4,871,705; 4,933,403; 4,937,299; 5,017,714; 5,026,798; 5,057,475; 5,120,867; 5,278,119; 5,304,614; 5,324,800; 5,350,723; and 5,391,790 each fully incorporated herein by reference.

Methods for preparing metallocenes are fully described in the Journal of Organometallic Chem., volume 288, (1985), pages 63-67, and in EP-A- 320762, both of which are herein fully incorporated by reference.

Metallocene catalyst components are described in detail in U.S. Pat. Nos. 5,145,819; 5,243,001; 5,239,022; 5,329,033; 5,296,434; 5,276,208; 5,672,668; 5,304,614; 5,374,752; 5,240,217; 5,510,502 and 5,643,847; and EP 549 900 and 576 970 all of which are herein fully incorporated by reference.

Illustrative but non-limiting examples of desirable metallocenes include:

Dimethylsilanylbis(2-methyl-4-phenyl-1-indenyl)ZrCl₂;

Dimethylsilanylbis(2-methyl-4,6-diisopropylindenyl)ZrCl₂;

Dimethylsilanylbis(2-ethyl-4-phenyl-1-indenyl)ZrCl₂;

Dimethylsilanylbis(2-ethyl-4-naphthyl-1-indenyl)ZrCl₂,

Phenyl(Methyl)silanylbis(2-methyl-4-phenyl-1-indenyl)ZrCl₂,

Dimethylsilanylbis(2-methyl-4-(1-naphthyl)-1-indenyl)ZrCl₂,

Dimethylsilanylbis(2-methyl-4-(2-naphthyl)-1-indenyl)ZrCl₂,

Dimethylsilanylbis(2-methyl-indenyl)ZrCl₂,

Dimethylsilanylbis(2-methyl-4,5-diisopropyl-1-indenyl)ZrCl₂,

Dimethylsilanylbis(2,4,6-trimethyl-1-indenyl)ZrCl₂,

Phenyl(Methyl)silanylbis(2-methyl-4,6-diisopropyl-1-indenyl)ZrCl₂,

1,2-Ethandiylbis(2-methyl-4,6-diisopropyl-1-indenyl)ZrCl₂,

1,2-Butandiylbis(2-methyl-4,6-diisopropyl-1-indenyl)ZrCl₂,

Dimethylsilanylbis(2-methyl-4-ethyl-1-indenyl)ZrCl₂,

Dimethylsilanylbis(2-methyl-4-isopropyl-1-indenyl)ZrCl₂,

Dimethylsilanylbis(2-methyl-4-t-butyl-1-indenyl)ZrCl₂,

Phenyl(Methyl)silanylbis(2-methyl -4-isopropyl-1-indenyl)ZrCl₂,

Dimethylsilanylbis(2-ethyl-4-methyl-1-indenyl)ZrCl₂,

Dimethylsilanylbis(2,4-dimethyl-1-indenyl)ZrCl₂,

Dimethylsilanylbis(2-methyl-4-ethyl-1-indenyl)ZrCl₂,

Dimethylsilanylbis(2-methyl-1-indenyl)ZrCl₂,

Activators: Metallocenes are generally used in combination with some form of activator. Alkylalumoxanes may be used as activators, most desirably methylalumoxane (MAO). There are a variety of methods for preparing alumoxane, non-limiting examples of which are described in U.S. Pat. No. 4,665,208, 4,952,540, 5,091,352, 5,206,199, 5,204,419, 4,874,734, 4,924,018, 4,908,463, 4,968,827, 5,308,815, 5,329,032, 5,248,801, 5,235,081, 5,103,031 and EP-A-0 561 476, EP-B1-0 279 586, EP-A-0 594-218 and WO94/10180, each fully incorporated herein by reference. Activators may also include those comprising or capable of forming non-coordinating anions along with catalytically active metallocene cations. Compounds or complexes of fluoro aryl-substituted boron and aluminum are particularly suitable, see, e.g., U.S. Pat. Nos. 5,198,401; 5,278,119; and 5,643,847.

Support Materials: The catalyst compositions used in the process of this invention may optionally be supported using a porous particulate material, such as for example, talc, inorganic oxides, inorganic chlorides and resinous materials such as polyolefin or polymeric compounds.

Desirably, the support materials are porous inorganic oxide materials, which include those from the Periodic Table of Elements of Groups 2, 3, 4, 5, 13 or 14 metal oxides. Silica, alumina, silica-alumina, and mixtures thereof are particularly desirable. Other inorganic oxides that may be employed either alone or in combination with the silica, alumina or silica-alumina are magnesia, titania, zirconia, and the like.

A particularly desirable support material is particulate silicon dioxide. Particulate silicon dioxide materials are well known and are commercially available from a number of commercial suppliers. Desirably the silicon dioxide used herein is porous and has a surface area in the range of from about 10 to about 700 m²/g, a total pore volume in the range of from about 0.1 to about 4.0 cc/g and an average particle diameter in the range of from about 10 to about 500 μm. More desirably, the surface area is in the range of from about 50 to about 500 m²/g, the pore volume is in the range of from about 0.5 to about 3.5 cc/g and the average particle diameter is in the range of from about 15 to about 150 μm. Most desirably the surface area is in the range of from about 100 to about 400 m²/g, the pore volume is in the range of from about 0.8 to about 3.0 cc/g and the average particle diameter is in the range of from about 20 to about 100 μm. The average pore diameter of typical porous silicon dioxide support materials is in the range of from about 10 to about 1000Å. Desirably, the support material has an average pore diameter of from about 50 to about 500Å, and most desirably from about 75 to about 350Å. Desirably, supports suitable for use in this invention include talc, clay, silica, alumina, magnesia, zirconia, iron oxides, boria, calcium oxide, zinc oxide, barium oxide, thoria, aluminum phosphate gel, polyvinylchloride and substituted polystyrene and mixtures thereof.

The supported catalyst composition may be used directly in polymerization or the catalyst composition may be prepolymerized using methods well known in the art. For details regarding prepolymerization, see U.S. Pat. Nos. 4,923,833; 4,921,825; and 5,643,847; and EP 279 863 and EP 354 893 (each fully incorporated herein by reference).

### Polymerization

The copolymer, which is the co-polymerization reaction product of α,ω-diene(s) and olefin(s) may desirably be prepared by slurry polymerization of the olefins and the diene under conditions in which the catalyst site remains relatively insoluble and/or immobile so that the polymer chains are rapidly immobilized following their formation. Such immobilization is affected, for example, by (1) using a solid, insoluble catalyst, (2) conducting the copolymerization in a medium in which the resulting copolymer is generally insoluble, and (3) maintaining the polymerization reactants and products below the crystalline melting point of the copolymer.

Generally, the metallocene supported catalyst compositions described above, and in greater detail in the Examples below, are desirable for co-polymerizing α,ω-dienes and olefins. The polymerization processes suitable for co-polymerizing α,ω-dienes and olefins, and particularly α-olefins, are well known by those skilled in the art and include solution polymerization, slurry polymerization, and low pressure gas phase polymerization. Metallocene supported catalysts compositions are particularly useful in the known operating modes employing fixed-bed, moving-bed, fluid-bed, or slurry processes conducted in single, series or parallel reactors.

Generally, any of the above polymerization process may be used. When propylene is the selected olefin, a common propylene polymerization process is one that is conducted using a slurry process in which the polymerization medium can be either a liquid monomer, like propylene, or a hydrocarbon solvent or diluent, advantageously aliphatic paraffin such as propane, isobutane, hexane, heptane, cyclohexane, etc. or an aromatic diluent such as toluene. In this instance, the polymerization temperatures may be those considered low, e.g., less than 50° C., desirably 0° C.-30°60 C., or may be in a higher range, such as up to about 150° C., desirably from 50° C. up to about 80° C., or at any ranges between the end points indicated. Pressures can vary from about 100 to about 700 psia (0.69-4.8 MPa). Additional description is given in U.S. Pat. Nos. 5,274,056 and 4,182,810 and WO 94/21962 which are each fully incorporated by reference.

More particularly, the polymerization method of forming a propylene/α,ω-diene copolymer includes contacting a catalyst, and desirably a metallocene catalyst, under suitable polymerization conditions with polymerizable reactants, such as propylene monomers, and α,ω-diene monomers and recovering the propylene/α,ω-diene copolymer. Desirably the metallocene catalyst may be a zirconium metallocene catalyst. Additionally, the contacting step may include hydrogen and ethylene monomers. The hydrogen, in ppm, may be present in the range of 100 to 50,000 and desirably from 500 to 20,000 and most desirably from 1,000 to 10,000 measured as gas phase concentration in equilibrium with liquid propylene at polymerization temperatures. The α,ω-diene monomers, in wt % based upon the total weight of the monomers introduced into the polymerization reactor, may be present in the range of 0.001 to 2 and desirably from 0.003 to 2 and more desirably from 0.003 to 1.5. The ethylene monomers, in wt % based upon the total weight of the monomers introduced into the polymerization reactor, may be present in the range of 0 to 8 and desirably from 1 to 7 and more desirably from 2 to 6. The polymerizable reactants, in wt % based upon the total weight of the monomer(s) introduced into the polymerization reactor, may be present in the range of 90 to 99.999 and desirably from 93 to 99.997 and more desirably from 95 to 99.995.

Pre-polymerization may also be used for further control of polymer particle morphology in typical slurry or gas phase reaction processes in accordance with conventional teachings. For example, this can be accomplished by pre-polymerizing a C₂-C₆ alpha-olefin for a limited time. For example, ethylene may be contacted with the supported metallocene catalyst composition at a temperature of −15 to 30° C. and ethylene pressure of up to about 250 psig (1724 kPa) for 75 min. to obtain a polyethylene coating on the support. The pre-polymerized catalyst is then available for use in the polymerization processes referred to above. In a similar manner, the activated catalyst on a support coated with a previously polymerized polymer can be utilized in these polymerization processes.

Additionally it is desirable to reduce or eliminate polymerization poisons that may be introduced via feedstreams, solvents or diluents, by removing or neutralizing the poisons. For example, monomer feed streams or the reaction diluent may be pre-treated, or treated in situ during the polymerization reaction, with a suitable scavenging agent. Typically such will be an organometallic compound employed in processes such as those using the Group-13 organometallic compounds of U.S. Pat. No. 5,153,157 and WO-A-91/09882 and WO-A-94/03506, noted above, and that of WO-A-93/14132.

### Modifiers

Modifiers may be those commonly employed with plastics. Examples include one or more of the following: heat stabilizers or antioxidants, neutralizers, slip agents, antiblock agents, pigments, antifogging agents, antistatic agents, clarifiers, nucleating agents, ultraviolet absorbers or light stabilizers, fillers, hydrocarbon resins, rosins or rosin esters, waxes, additional plasticizers and other additives in conventional amounts. Effective levels are known in the art and depend on the details of the base polymers, the fabrication mode and the end application. In addition, hydrogenated and/or petroleum hydrocarbon resins and other plasticizers may be used as modifiers.

The polypropylene copolymers described herein are suitable for applications such as molded articles, including injection and blow molded bottles and molded items used in automotive articles, such as automotive interior and exterior trims. Examples of other methods and applications for making polypropylene polymers and for which polypropylene polymers may be useful are described in the Encyclopedia of Chemical Technology, by Kirk-Othmer, Fourth Edition, vol. 17, at pages 748-819, which are incorporated by reference herein. In those instances where the application is for molded articles, the molded articles may include a variety of molded parts, particularly molded parts related to and used in the automotive industry, such as for example bumpers, side panels, floor mats, dashboards and instrument panels. Examples of other applications for which foamed plastic, such as foamed polypropylene, are useful may be found in Encyclopedia of Chemical Technology, by Kirk-Othmer, Fourth Edition, vol. 11, at pages 730-783, which are incorporated by reference herein. Foamed articles are particular useful for construction and automotive applications. Examples of construction applications include heat and sound insulation, industrial and home appliances, and packaging. Examples of automotive applications include interior and exterior automotive parts, such as bumper guards, dashboards and interior liners.

### EXAMPLES

General—Polymerization was conducted in either a two-liter autoclave reactor or a series of two 150 gallon stirred tanks, auto refrigerated boiling liquid reactor. Monomer feed and catalyst preparation procedures for each were similar. Polymerization grade propylene monomers were purified by passing first through basic alumina activated at 600° C., followed by molecular sieves activated at 600° C. 1,9-decadiene (96%) was purchased from Aldrich-Sigma Bulk Chemicals and used as received.

Melt flow rate (MFR) of the polymers was measured using ASTM D-1238 at 230° C. and 2.16 kg load. Molecular weight of the polymers was analyzed by GPC using Waters 150C high temperature system with a DRI detector and Showdex AT-806MS column. Melting and crystallization temperatures of the polymers were measured on a TA Instrument DSC-912 using a heating and cooling rate of 10° C./min with a starting temperature of 0° C. and a stopping temperature of 250° C. The melting temperatures reported were obtained from the second melt. The mechanical properties were measured using ASTM-1708 microtensile testing procedure. Recoverable compliance was measured in a Rheometrics Dynamic Stress Rheometer (DSR).

### Catalyst Preparation

All catalyst preparations were performed in an inert atmosphere with <1.5 ppm H₂O content. The silica support, available from Grace Davison, a subsidiary of W. R. Grace Co.-Conn. as Sylopol®952 having N₂ pore volume 1.63 cc/g and a surface area of 312 m²/g was calcined at 600° C. under a dry nitrogen flow for 8-24 hours to achieve a hydroxyl content of 0.8 to 1.2 mmol/g silica.

Catalyst A: In a nitrogen purged dry glove box, the metallocene, dimethylsilylbis(2-methyl-4-phenyl indenyl)zirconium dichloride (0.090 g, 0.143 mmole) was weighed into a 100 mL beaker. Methylalumoxane (MAO, 4.65 g, 30% in toluene) was added to the beaker. The mixture was stirred for 1 hour to dissolve and activate the metallocene. After 1 hour, the activated metallocene solution was diluted with 10 g of toluene and added slowly to the calcined silica (5.00 g) with manual mix until the slurry was uniform in color. The slurry was transferred to a 250 mL flask connected to an inline glass frit. Solvent was removed by vacuum and catalyst was dried under vacuum. Metallocene loading was found to be 0.022 mmol of transition metal per gram of the catalyst.

Catalyst B: In a nitrogen purged dry glove box, the calcined silica (394.32 g) was weighed and placed in a 3-neck, 4 L reactor that was fitted with an overhead stirrer. The dry toluene, 2 L, was added and the mixture was stirred vigorously. The N.N-diethylaniline (27.6 ml, 0.174 mole) was added using a syringe. The tris(perfluorophenyl)boron (85.96 g, 0.168 mole) was added as a solid. The above mixture was stirred for 1 hour. The metallocene, dimethylsilylbis(2-methyl-4-phenyl indenyl)zirconium dimethyl (5.99 g, 0.0102 mole) was added and the reaction mixture was stirred for additional 2 hours. The solvent was decanted off and the solid was dried under vacuum overnight. Metallocene loading was found to be 0.02 mmol of transition metal per gram of catalyst.

Catalyst C: In a nitrogen purged dry glove box, the calcined silica (500 g) was charged to vessel that was equipped with an overhead stirrer. A solution of tris(perfluorophenyl)boron (30 g, 0.059 mole) in hexane (2 L), was added to silica followed by addition of N.N-diethylaniline (9.6 ml, 0.061 mole). The mixture was stirred at 49° C. for 1 hour. In a separate container, dimethylsilylbis(2-methyl-4-phenyl indenyl)zirconium dimethyl (4.5 g, 0.0077 mole), hexane (820 mL), triethylaluminium (187 mL, 25 wt % in heptane), and 1,9-decadiene (10 mL) were mixed to form a slurry. The 1,9-decadiene is used in this instance as a Lewis base to stabilize the catalyst, for instance by improving its shelf life. Other Lewis bases, such as other dienes including those described above and styrene, are known to be suitable for stabilizing the catalyst and may also be used. The slurry was then transferred to the silica-containing vessel, and the mixture was stirred at 49° C. for additional 1 hour. The solvent was removed by purging with nitrogen for 14 hours, and a free flowing solid catalyst was obtained. Metallocene loading was 0.015 mmol of transition metal per gram of catalyst.

### Example 1

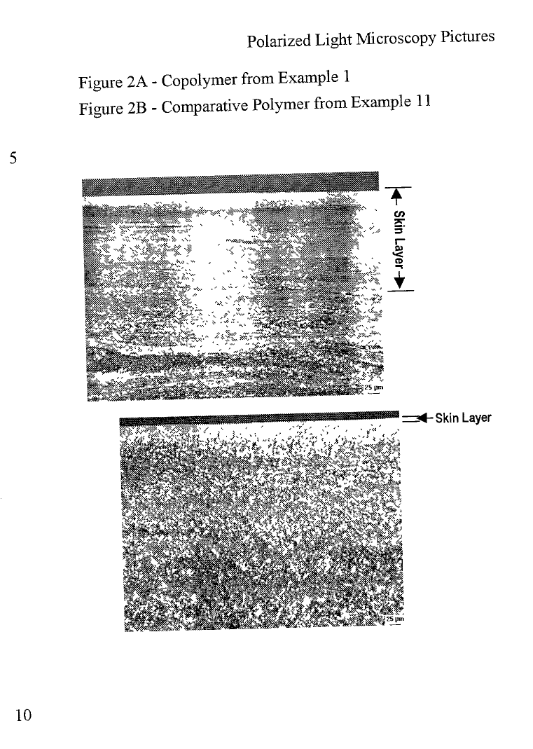

Polymerization was conducted in a 2-liter autoclave reactor. The reactor was charged with triethylaminium (TEAL, 0.5 mL of 1M solution in hexane), 1,9-decadiene (0.12 mL or 100 ppm)), and hydrogen (30 mmole). Then, liquid propylene (1 L) was added to the reactor, and the catalyst A (200 mg in mineral oil) was injected with another 200 cc of propylene. The reactor was heated to the 70° C. with stirring. After 1 hour, the reactor was cooled to 25° C. and vented. The polymer was collected, and dried in air for 8 hours (yield: 200 g). The product had a MFR of 26 dg/min. The GPC measurement of this product gave a number average molecular weight (Mn) of 19,000 and a weight average molecular weight (Mw) of 167,000. The polymer had a melting point of 153.3° C., and crystallization temperature of 122.6° C. The recoverable compliance was 18.6× 10⁻⁵ cm²/dyne, and the polymer showed strong strain hardening in extensional viscosity measurement. Mechanical properties measured on the molded polymer were also advantageous. The heat distortion temperature (HDT) of the polymer was 129° C., and Flexual Modulus was 311 kpsi, much higher than conventional Ziegler-Natta(Z/N)-catalyzed and metallocene-catalyzed polypropylene resins. These are likely the result of formation of a thick skin layer structure in the injection-molded polymer as shown in FIG. 2A and discussed in greater detail below.

### Example 2

A 2-liter autoclave reactor was charged with triethylaminium (TEAL, 0.6 mL of 1M solution in hexane), 1,9-decadiene (0.50 mL or 400 ppm), and hydrogen (24 mmole). Then, liquid propylene (1 L) was added to the reactor, and the reactor was heated to the 70° C. with stirring. The catalyst B (101 mg) was injected with another 250 cc of propylene. The reactor temperature was kept at 70° C. After 1 hour, the reactor was cooled to 25° C. and vented. The polymer was collected, and dried in air for 8 hours (yield: 246 g). The product had a MFR of 3.2 dg/min. The GPC measurement of this product gave a number average molecular weight (Mn) of 48,000 and a weight average molecular weight (Mw) of 221,000. The polymer had a melting point of 155.1° C., and crystallization temperature of 115.9° C. The recoverable compliance was 42.1×10⁻⁵ cm²/dyne.

### Example 3-10

Propylene/diene copolymers were produced in a series of two 150 gallon stirred tanks, auto refrigerated boiling liquid reactors. Catalyst C was used. The conditions in the two reactors were as follows:

| | Reactor 1 | Reactor 2 |
|---|---|---|
| Reaction Temperature (° F.) | 165 | 155 |
| Propylene flow rate (lb/hr) | 175 | 65 |
| Gas phase H₂ conc. (ppm) | 3500-2500 | 3500-2500 |
| Solid Concentration (wt %) | 25-30 | 25-30 |

All polymers were made with varying levels of 1,9-decadiene (4.5-9.5% in hexane) charged to reactor 1. From example 3 to 8, the H₂ was kept at 3000 ppm while diene concentration was increased from 125-375 ppm. In examples 9-13, both H₂ and diene concentrations were adjusted to obtain the polymers with desired MFR (Table 1). Some characterization data are also listed in Table 1. The melting point of the propylene/diene copolymers ranged from 153-155° C., similar to that of propylene homopolymer made under similar conditions (comparative example 14) and ΔH_{f}'s were also comparable, indicating similar crystallinity. However, a much higher and nearly constant crystallization temperature of ˜124-125° C. was observed (Tc of comparative example 14 was 112.4° C.). This is also higher than those of the propylene/diene copolymers illustrated in Comparative Examples 15 and 16, as well as in U.S. Pat. No. 5,670,595 and patent application WO9911680. Higher Tc could significantly reduce the cycle time in a polymer fabrication process such as injection molding.

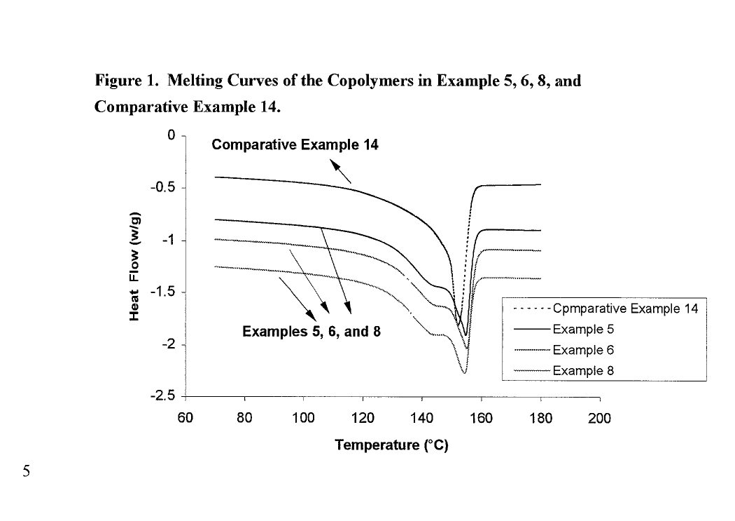

The unique thermal properties of the copolymers of this invention may be demonstrated in their melting behavior. FIG. 1 shows the melting curves of the invention copolymers (Examples 5, 6, and 8) compared to the comparative example 14. The inventive copolymers have at least two crystalline populations wherein the melting point range of one of the crystalline populations is distinguishable from the melting point range of the other crystalline population by at least 1° C., desirably by at least 2° C., more desirably by at least 3° C., and still more desirably by a temperature range from 1° C. to 8° C. and still more desirably by a temperature range from 2° C. to 4° C. More specifically, in addition to a melting point of one of the populations, such as a predominant crystalline population, at around 155° C. (in a temperature range of between 152° C. and 158° C.), another shoulder, indicating another crystalline population, having a melting point at around 145° C. (in a temperature range of between 142° C. and 148° C.) is observed. The presence of multiple crystalline populations having different melting points significantly broadens the melting peak of the copolymer. This property is highly desired in the applications such as thermoforming where a broadened melting range translates to a broader forming window.

Some representative data on the tensile properties measured at 2″ per minute are listed in Table 1. Comparing samples 3-10 to the data in U.S. Pat. No. 5,670,595, it will be noted that the copolymer represented by these samples possess a significant increase in modulus values. The significantly higher modulus will be advantageous in applications requiring/demanding higher rigidities. Use of these inventive copolymers could, for example, allow a molder to forgo the incorporation of high filler loading (talc-calcium carbonate), with obvious cost and performance benefits.

### Comparative Example 11

This example demonstrates that the homopolypropylene made with same metallocene catalyst does not show the property enhancement as those observed for the propylene/diene copolymer. The homopolymer was produced in the same reactor as described in Examples 3-10. Catalyst C was used. The conditions in the two reactors were as follows:

| | Reactor 1 | Reactor 2 |
|---|---|---|
| Reaction Temperature (° F.) | 165 | 155 |
| Propylene flow rate (lb/hr) | 175 | 65 |
| Gas phase H₂ conc. (ppm) | 3500 | 3500 |
| Solid Concentration (wt %) | 25-30 | 25-30 |

No 1,9-decadiene was added during propylene polymerization. The product had a MFR of 20.4 dg/min. The GPC measurement of this product gave a number average molecular weight (Mn) of 55,000 and a weight average molecular weight (Mw) of 155,000. The polymer had a melting point of 152.2° C., and crystallization temperature of 112.9° C. The recoverable compliance was 1.32×10⁻⁵ cm²/dyne, and the polymer did not show strain hardening in extensional viscosity measurement.

### Comparative Example 12

This example demonstrates that the propylene/diene copolymer made with conventional Ziegler-Natta catalyst does not show the property enhancement as those observed in the disclosed copolymers. The copolymer was made in a 2-liter autoclave reactor. The reactor was charged with triethylaminium (TEAL, 2.0 mL, 1M solution in hexane), dicyclopentyl dimethoxysilane (DCPMS, 2.0 mL, 0.1M solution in hexane), 1,9-decadiene (2.0 mL), and hydrogen (150 mmole). Then, liquid propylene (1 L) was added to the reactor, and the catalyst (TOHO, 200 mg, 5 wt % in mineral oil) was injected with another 250 cc of propylene. The reactor was heated to the 70° C. with stirring. After 1 hour, the reactor was cooled to 25° C. and vented. The copolymer was collected, and dried in air for 8 hours (yield: 460 g). The product had a MFR of 4.2 dg/min. The GPC measurement of this product gave a number average molecular weight (Mn) of 101,000 and a weight average molecular weight (Mw) of 567,000. The copolymer had a melting point of 168.7° C., and crystallization temperature of 114.2° C. The recoverable compliance was 4.22×10⁻⁵ cm²/dyne, and the copolymer did not show strain hardening in extensional viscosity measurement.

### Comparative Example 13

This example demonstrates that the propylene/diene copolymer made with the catalyst/conditions other than the ones used in this invention does not show the property enhancement as those observed in the disclosed compositions. (The propylene/diene copolymer was made under similar conditions as those described in U.S. Pat. No. 5,670,595). A 2-liter autoclave reactor was charged with triisobutylaminium (2.0 mL of 1M solution in toluene), 1,9-tetradecadiene (1.0 mL), liquid propylene (200 mL), and toluene (600 mL). The reactor was heated to 60° C. with stirring and equilibrated for 3 minutes. Catalyst (3.5 mg of dimethylsilyl bis(indenyl) halnium dimethyl and 4 mg of N,N-dimethylanalynium tetrakis(perflurophenyl) borate dissolved together in 5 mL of toluene) was injected into the reactor. The polymerization was allowed to run for 30 min, then the reactor was cooled to 25° C. and vented. The copolymer was precipitated into methanol, filtered, and dried in air for 8 hours (yield: 25 g). The product had a MFR of 40 dg/min. The GPC measurement of this product gave a number average molecular weight (Mn) of 73,000 and a weight average molecular weight (Mw) of 150,000. The polymer had a melting point of 133.6° C., and crystallization temperature of 93.5° C. Tensile test on the polymer gave tensile strength and modulus of 4,130 psi and 93,600 psi, respectively. The recoverable compliance was 5.05×10⁻⁵ cm²/dyne.

TABLE 1
Characterization of the Polymers in Examples and Comparative Examples.

| | | Diene | | MFR | | | | | Compliance | Modulus |
|---|---|---|---|---|---|---|---|---|---|---|
| Example | Catalyst* | (ppm) | H₂ | (dg/min) | Mn | Mw | Tm (° C.) | Tc (° C.) | (10⁵ cm²/dyne) | (psi) |
| 1 | A | 100 | 30 mmol | 27 | 19,000 | 167,000 | 153.3 | 122.6 | 18.6 | 103,900 |
| 2 | B | 400 | 24 mmol | 3.2 | 48,000 | 221,000 | 155.1 | 115.9 | 42.1 | 89,800 |
| 3 | C | 175 | 3000 ppm | 10 | 79,000 | 271,000 | 153.9 | 122.2 | 15.2 | 111,700 |
| 4 | C | 250 | 3000 ppm | 5 | 97,000 | 355,000 | 154.6 | 124.4 | 16.8 | 95,280 |
| 5 | C | 250 | 3000 ppm | 4 | 102,000 | 391,000 | 155.0 | 125.0 | 13.3 | 98,990 |
| 6 | C | 350 | 3000 ppm | 3 | 128,000 | 453,000 | 154.4 | 125.1 | 10.3 | 113,670 |
| 7 | C | 375 | 3000 ppm | 2 | 129,000 | 467,000 | 154.3 | 125.6 | 14.8 | 110,400 |
| 8 | C | 375 | 4000 ppm | 7 | ** | ** | 154.0 | 124.8 | 17.2 | 123,770 |
| 9 | C | 375 | 3500 ppm | 5 | 102,000 | 394,000 | 154.3 | 124.9 | 10.1 | 114,800 |
| 10 | C | 350 | 3000 ppm | 4 | 115,000 | 432,000 | 154.1 | 125.6 | 7.0 | 99,580 |
| Comparative 11 | C | 0 | 3000 ppm | 20 | 64,000 | 184,000 | 152.2 | 112.9 | 1.3 | 112,770 |
| Comparative 12 | D | 1600 | 150 mmol | 4.2 | 101,000 | 567,000 | 168.7 | 114.2 | 4.2 | 86,260 |
| Comparative 13 | E | 1250 | — | 40 | 73,333 | 93,600 | 133.6 | 93.5 | 5.1 | 93,600 |

*Catalyst: A, B, and C -- see Catalyst Preparation Section. D -- Conventional Z-N catalyst, TOHO. E -- Dimethylsilyl bis(indenyl) halnium dimethyl activated with N,N-dimethylanalynium tetrakis(perflurophenyl).
** -- Not measure

### Polarized Light Microscopy

Generally, the outer surface of a molded item formed from a polymer material may be referred to as the “skin-layer”. Furthermore, it has been observed that the morphology (the solid-state molecular arrangement and structure) of the outer most surface of molded items, and particularly injection molded items, is different than that of the core. Observing a cross-sectional portion of a molded article under a polarized light microscope, the skin layer can be distinguished from the core by the molecular orientation, and desirably, generally parallel molecular orientation of the polymer proximate to the surface of the molded article. Additionally, the molecular orientation and thickness of the skin layer can be related to the birefringence value of the article as measured by a Metricon Model 2010 Prism coupler. For example, polymers may be injection molded at temperatures between approximately 200° C. to 250° C. into bars (125 mm×12 mm ×3.0 mm) and plaques (75 mm×50 mm×10.0 mm). The reflective indices (RI) were measured at the three principle axis, machine direction (MD), transverse direction (TD) and normal direction (ND). The in-plane birefringence (IBR) and planar birefringence (PBR) can be defined by the equations:

IBR=RI(MD)−RI(TD)

PBR=(RI(MD)+RI(TD))/2−RI(ND).

Additional reference information relative to birefringence, IBR and PBR appears in U.S. Pat. No. 5,385,704, which is incorporated by reference herein.

Since the properties and thus the use of molded articles depends on the morphology of the article, the thickness of the skin layer influences the properties of the molded article. Depending upon the type and degree of morphology differences in the skin and core, the properties can either be detrimental or useful. Generally, a molded article having a thinner skin layer is less rigid than a similarly molded article having a thicker skin layer. Examples of applications generally requiring molded articles having higher rigidity include injection and blow molded bottles for good top load strength and molded items used in automotive articles, such as automotive interior and exterior trims where rigidity and resistance to marking and scuffing is desired.

### Experimental

The molten propylene/1,9-decadiene copolymer from Example 1 and metallocene-polymerized homopolypropylene from Comparative Example 11 were separately injected into a rectangular mold (127 mm×12.7 mm×3.175 mm) in a Butler Laboratory Injection Molder (Model No. 10/90V) at a temperature of 190° C. and a pressure of 30 psi to create specimen bars of substantially similar dimension as that of the rectangular mold. Each specimen's cross section was examined under a polarized light microscope. A partial cross-sectional microscopic view of each specimen is shown in FIGS. 2A and 2B. Referring now to FIG. 2A, the copolymer from Example 1 clearly shows a skin layer of 70-80 μm (or about 2×10⁻¹ percent of the total thickness of the specimen at the point of measurement), which is significantly thicker than the skin layer of the conventional metallocene polypropylene, FIG. 2B. The metallocene polypropylene (Comparative Example 11) shown in FIG. 1B has a skin layer less than 5 μm (or about 1×10⁻² percent of the total thickness of the specimen at the point of measurement).

The IBR and PBR values for the polymers of Examples 4, 5 and 8 and Comparative Example 11 are listed in Table 2. These data illustrates that between 2 to 7 times higher birefringence values were obtained for Examples 4, 5 and 8 as compared to Comparative Example 11. Higher birefringence values are further indicative of a greater degree of molecular orientation at the surface or skin layer.

TABLE 2
Birefringence of Inventive and Comparison Examples

| | In-plane Birefringence | Planar Birefringence |
|---|---|---|
| Example | (x10⁻³) | (x10⁻³) |
| Example 4 (tensile bar) | 13.1 | 7.60 |
| Comparative Ex. 11 | 3.90 | 3.25 |
| (tensile bar) | | |
| Example 4 (plaque) | 14.5 | 7.75 |
| Example 5 (plaque) | 12.3 | 5.95 |
| Example 8 (plaque) | 8.60 | 4.25 |
| Comparative Ex. 11 | 2.00 | 1.90 |
| (plaque) | | |

While the skin layer dimension may be dependent on the dimensions of the molded article, it is desirable that the skin layer of a molded article formed by polymers and particularly by copolymers described herein, under the conditions describe in the above paragraph have a skin layer thickness in the range of from 10 μm to 120 μm, desirably from 20 μm to 110 μm and more desirably from 30 μm to 100 μm. Additionally, it is desirable that the skin layer of a molded article, such as a bottle or automotive part, such as an interior or exterior trim article, formed by polymers, and particularly by copolymers described herein, have a thickness proportional to the thickness of the molded article of from 0.1 to 1×10⁻² percent of the total thickness of the molded article at the point of measurement and more desirably from 5×10⁻¹ to 5×10⁻² percent of the total thickness of the molded article at the point of measurement.

In addition to the skin layer difference between these polypropylenes, there are differences in the overall morphology of the two polymers. The inventive copolymers have smaller spherulite compared to the comparative polymer. Such differences clearly point out the difference in the compositions of the two polymers due to their synthesis and process conditions of preparation.

### Extensional Viscosity

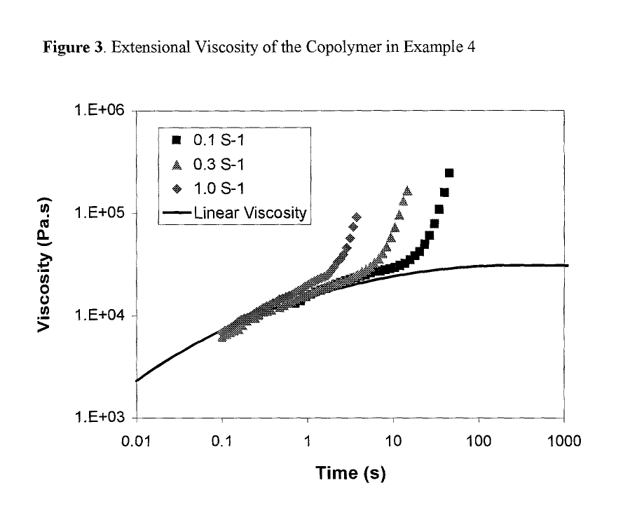

Melt rheology data demonstrated the enhanced melt elasticity and melt strength of the inventive copolymers as evidenced by their high recoverable compliance. This may be reinforced by the extensional viscosity measurement. FIG. 3 shows a typical plot of extensional viscosity behavior of the copolymer described in Example 4. Significant strain hardening was observed at all elongational rates tested.

The extensional viscosity data were obtained using a Rheometric Melt Elongational Rheometer (RME) in an extensional strain mode at 160° C. The polymers were stabilized with 0.1-0.2 wt % of BHT (2,6-di tert-butyl-4-methylphenol, a common antioxidant) and molded into a rectangular specimen (60 ×8×2 mm). The distance between the clamps was set at 50 mm.

### Extensional Viscosity Measurement

The raw data are the evolution of the tensile force versus time, F(t), which are converted into extensional viscosity values. The elongational stress and elongational viscosities are given respectively by equation 1:

$$σ ( t ) = \frac{F ( t )}{S ( t )} and {η}_{E} ( t ) = \frac{σ ( t )}{\dot{ϵ}} \qquad [ 1 ]$$

where S(t) is the sample cross-section and 9 the elongation rate. Instead of using the command value on the instrument, the latter quantity was determined by an image analysis procedure. During homogeneous stretching conditions, the sample length increases exponentially with time. Thus, assuming iso-volume conditions (incompressible melt), S(t) follows according to equations 2:

S(t)=S₀ exp(−\acute{ε}t) [2]

It is more convenient to measure the sample width l(t) during stretching. Under uniaxial deformation, it is expressed by equations 3:

$$l ( t ) = {l}_{0} exp ( - \frac{\dot{ϵ} t}{2} ) \qquad [ 3 ]$$

Throughout a run, a plot of [−2 ln (l(t)/l₀] as a function of time is a straight line with a slope equal to \acute{ε}. True elongational rates were determined according to this procedure for each test.

As a caution, Equations [1]-[3] were applied only if the two following criteria were verified:

force values higher than the minimum transducer resolution (0.2 cN), and;

homogeneous deformation, i.e. no neck-in, and no deviation from linearity in the plots of [−2 ln (l(t)/l₀] vs time.

In case of failure of only one of these criteria, the corresponding F(t) values are not converted into elongational viscosity data, as the conversion may not be reliable. It is to be noted that the second criterion is generally the most severe test of the measurements and their reliability.

### Linear Viscoelastic Predictions

For comparison, it is useful to plot the experimental data together with the predictions of linear viscoelasticity, which can be independently evaluated by strain oscillatory experiments. These experiments have been performed on a RMS800 or a SR-500 from Rheometric Scientific. Discrete relaxation spectra were calculated with the established method of Baumgaertel and Winter using Iris software. Transient elongational viscosity were then computed as 3 times the strain value using equation 4:

$${\overline{η}}_{E} ( t ) = 3 {\sum }_{i} {g}_{i} {λ}_{l} ( 1 - exp ( \frac{- t}{{λ}_{i}} ) ) . \qquad [ 4 ]$$

### Stain Hardening

The ratio of the extensional viscosity of the measured polymer at break to the linear viscosity can be calculated for each of the strain rates. Stain hardening is defined as when the ratio is greater than 1. The data and plot for a typical inventive copolymer (Example 4) are shown in Table 3, 4, 5, and FIG. 3, respectively. For a strain rate of 0.1 l/second (1/s), the ratio is 8.45. For a strain rate of 0.3 l/s, the ratio is 6.47. For a strain rate of 1.0 l/s, the ratio is 4.47. The numerical data and the plot once again demonstrated melt viscosity differences among the inventive and comparative examples. The comparative polymers did not show strain hardening and behaved as linear viscoelastic materials. The different behavior of inventive copolymers is obviously a result of their different molecular architecture.

TABLE 3
Extensional Viscosity and Linear Viscoelasticity for Example
4 at a Strain rate of 0.1 1/s

| Time (s) | Extensional Vis. (Pa · s) | Linear Vis. (Pa · s) |
|---|---|---|
| 0.73719511 | 13148.1279 | 14126.5878 |
| 0.84221171 | 13959.0188 | 14650.539 |
| 0.96218837 | 15401.1142 | 15176.7008 |
| 1.09925623 | 16176.6296 | 15703.5878 |
| 1.25584998 | 17116.971 | 16230.6479 |
| 1.43475119 | 17772.9567 | 16758.2947 |
| 1.63913764 | 18484.0622 | 17287.6499 |
| 1.87263982 | 19407.1547 | 17820.0532 |
| 2.13940538 | 20352.7483 | 18356.4688 |
| 2.44417284 | 21120.4969 | 18896.9646 |
| 2.79235572 | 21988.2077 | 19440.4354 |
| 3.19013875 | 22706.9563 | 19984.6755 |
| 3.64458767 | 23444.3592 | 20526.7912 |
| 4.16377479 | 24344.293 | 21063.8272 |
| 4.75692234 | 25044.1845 | 21593.4081 |
| 5.4345663 | 26172.1222 | 22114.2008 |
| 6.20874354 | 27010.2425 | 22626.0619 |
| 7.09320564 | 27288.786 | 23129.8273 |
| 8.10366315 | 27989.4387 | 23626.7978 |
| 9.25806467 | 28785.9558 | 24118.0598 |
| 10.5769156 | 29447.8667 | 24603.843 |
| 12.0836425 | 30828.8321 | 25083.1232 |
| 13.8050092 | 32262.3771 | 25553.6153 |
| 15.7715918 | 35142.3204 | 26012.1753 |
| 18.0183226 | 38411.8278 | 26455.4914 |
| 20.5851098 | 41946.2536 | 26880.8465 |
| 23.5175469 | 49557.3084 | 27286.7196 |
| 26.8677221 | 60905.1118 | 27673.0543 |
| 30.6951442 | 79272.56 | 28041.1164 |
| 35.0677989 | 108165.257 | 28392.9712 |
| 40.063357 | 158551.065 | 28730.7061 |
| 45.7705537 | 245629.428 | 29055.6007 |

TABLE 4
Extensional Viscosity and Linear Viscoelasticity for the Product
of Example 4 at a Strain rate of 0.3 1/s

| Time (s) | Extensional Vis. (Pa · s) | Linear Vis. (Pa · s) |
|---|---|---|
| 0.1 | 6198.05504 | 7231.15979 |
| 0.11171247 | 6617.11907 | 7557.8095 |
| 0.12479676 | 6865.79687 | 7892.99628 |
| 0.13941355 | 7187.56608 | 8236.31541 |
| 0.15574232 | 7469.58659 | 8587.1569 |
| 0.1739836 | 8116.40852 | 8944.78562 |
| 0.19436138 | 8983.09863 | 9308.45678 |
| 0.2171259 | 9733.0773 | 9677.54269 |
| 0.24255671 | 9539.14485 | 10051.6425 |
| 0.27096609 | 10226.3339 | 10430.6494 |
| 0.30270292 | 10969.2674 | 10814.7565 |
| 0.33815692 | 11157.1453 | 11204.397 |
| 0.37776345 | 11459.2584 | 11600.124 |
| 0.47143656 | 12185.514 | 12411.6853 |
| 0.52665343 | 12813.4974 | 12827.7886 |
| 0.58833757 | 13394.4292 | 13250.3017 |
| 0.65724644 | 13979.5762 | 13678.3551 |
| 0.73422624 | 14615.3944 | 14110.7678 |
| 0.82022228 | 15352.8647 | 14546.2189 |
| 0.91629059 | 15909.4747 | 14983.4544 |
| 1.02361086 | 16609.2458 | 15421.4855 |
| 1.143501 | 17192.8332 | 15859.7361 |
| 1.27743323 | 17710.5588 | 16298.109 |
| 1.42705223 | 18376.1697 | 16736.9533 |
| 1.59419532 | 18965.4083 | 17176.9379 |
| 1.780915 | 19692.3001 | 17618.8494 |
| 1.98950417 | 20361.3558 | 18063.3536 |
| 2.22252428 | 21034.5762 | 18510.7671 |
| 2.48283681 | 21690.9629 | 18960.8913 |
| 2.77363837 | 22409.3022 | 19412.949 |
| 3.09849999 | 23151.0493 | 19865.6436 |
| 3.46141092 | 24246.5742 | 20317.3306 |
| 3.8668277 | 25310.6942 | 20766.2647 |
| 4.3197288 | 26898.7373 | 21210.8674 |
| 4.82567582 | 28340.5261 | 21649.9579 |
| 5.39088174 | 30115.7569 | 22082.8986 |
| 6.02228724 | 32755.8339 | 22509.6275 |
| 6.72764594 | 35956.2693 | 22930.5697 |
| 7.51561957 | 40655.7278 | 23346.4441 |
| 8.39588439 | 47460.6076 | 23758.0011 |
| 9.37924998 | 58383.7171 | 24165.7436 |
| 10.477792 | 72886.8037 | 24569.6916 |
| 11.7050004 | 96723.7246 | 24969.2458 |
| 13.0759453 | 131862.017 | 25363.1864 |
| 14.6074617 | 166559.764 | 25749.813 |

TABLE 5
Extensional Viscosity and Linear Viscoelasticity for the Product
of Example 4 at a Strain rate of 1.0 1/s

| Time (s) | Extensional Vis. (Pa · s) | Linear Vis. (Pa · s) |
|---|---|---|
| 0.1 | 7231.15979 | 6841.15022 |
| 0.10900105 | 7484.59819 | 7258.87882 |
| 0.11881228 | 7743.24588 | 7468.42713 |
| 0.12950663 | 8006.94846 | 7727.07761 |
| 0.14116358 | 8275.46763 | 8150.60979 |
| 0.15386978 | 8548.49664 | 8719.48452 |
| 0.16771967 | 8825.68629 | 9214.2324 |
| 0.18281619 | 9106.67848 | 9483.48161 |
| 0.19927156 | 9391.14298 | 9665.7202 |
| 0.21720809 | 9678.81264 | 9994.22086 |
| 0.23675909 | 9969.51185 | 10543.9205 |
| 0.25806989 | 10263.1743 | 10958.2443 |
| 0.28129888 | 10559.847 | 11337.2595 |
| 0.30661872 | 10859.6792 | 11989.4676 |
| 0.33421761 | 11162.8968 | 12460.5611 |
| 0.36430069 | 11469.7641 | 12823.2966 |
| 0.39709157 | 11780.5382 | 13382.8379 |
| 0.43283396 | 12095.4194 | 13864.9321 |
| 0.47179355 | 12414.506 | 14475.6185 |
| 0.5142599 | 12737.7597 | 14864.2431 |
| 0.56054867 | 13064.9851 | 15388.5358 |
| 0.61100392 | 13395.8307 | 15870.9365 |
| 0.66600066 | 13729.809 | 16318.8859 |
| 0.72594769 | 14066.3359 | 17044.7605 |
| 0.79129058 | 14404.784 | 17766.7008 |
| 0.86251501 | 14744.5425 | 18605.8398 |
| 0.94015038 | 15085.0764 | 19494.5655 |
| 1.02477375 | 15425.9776 | 20414.3414 |
| 1.11701411 | 15766.9999 | 21091.6808 |
| 1.21755707 | 16108.0752 | 21788.0412 |
| 1.32714994 | 16449.3069 | 22643.9211 |
| 1.44660732 | 16790.942 | 23554.7582 |
| 1.57681712 | 17133.3232 | 24261.1117 |
| 1.71874716 | 17476.8269 | 24999.1982 |
| 1.87345238 | 17821.7937 | 27310.6889 |
| 2.0420827 | 18168.4606 | 30098.1859 |
| 2.2258915 | 18516.9025 | 33714.7089 |
| 2.42624503 | 18866.9935 | 36092.2486 |
| 2.64463246 | 19218.3925 | 39850.7624 |
| 2.88267705 | 19570.5569 | 46493.1496 |
| 3.14214815 | 19922.7827 | 57610.1807 |
| 3.42497436 | 20274.2663 | 74230.7018 |
| 3.73325788 | 20624.1791 | 92142.3706 |

### Heat Deflection Temperature (HDT) and Secant Modulus

The inventive copolymers were further tested using other standard ASTM methods. The copolymer samples were molded into test specimen. The HDT was determined using ASTM D-648 testing procedure, and 1% sec flex modulus was measured suing ASTM D-790A testing procedure. Data are presented in Table 6 and 7.

TABLE 6
Heat Deflection Temperature (HDT)

| Example | HDT (° C.) |
|---|---|
| Example 1 | 129.0 |
| Example 3 | 117.1 |
| Example 4 | 117.2 |
| Example 5 | 117.2 |
| Example 6 | 116.5 |
| Example 7 | 115.7 |
| Example 8 | 116.0 |
| Example 9 | 114.6 |
| Example 10 | 117.9 |
| Comparative Example 11 | 108.5 |

TABLE 7
1% Flexural Secant Modulus

| Example | 1% Sec Flex Mod. (kpsi) |
|---|---|
| Example 1 | 311 |
| Example 3 | 259 |
| Example 4 | 263 |
| Example 5 | 269 |
| Example 6 | 273 |
| Example 7 | 279 |
| Example 8 | 284 |
| Example 9 | 280 |
| Example 10 | 277 |
| Comparative Example 11 | 226 |

While the present invention has been described and illustrated by reference to particular embodiments, it will be appreciated by those of ordinary skill in the art that the invention lends itself to many different variations not illustrated herein. For these reasons, then, reference should be made solely to the appended claims for purposes of determining the true scope of the present invention.

Although the appendant claims have single appendencies in accordance with U.S. patent practice, each of the features in any of the appendant claims can be combined with each of the features of other appendant claims or the main claim.

We claim:

1. An article formed from a copolymer comprising from 90 to 99.999 weight percent of olefin units, from 0.001 to 2.000 weight percent of α,ω-diene units, wherein the copolymer has a weight average molecular weight in a range from 50,000 to 2,000,000, a crystallization temperature in a range from 115° C. to 135° C. and a melt flow rate in a range from 0.1 dg/min to 100 dg/min.

2. The article of claim 1 wherein the weight percent of α,ω-diene units present in the copolymer is from 0.005 to 1.5.

3. The article of claim 1 wherein the weight percent of α,ω-diene units present in the copolymer is from 0.005 to 1.0.

4. The article of claim 1 further defined as an article selected from a group including films, fibers, fabrics, molded articles, injection molded articles, foamed articles and blow molded articles.

5. The article of claim 4 further defined as an article selected from a group including bottles, cast films, oriented films, injection molded articles, blow molded articles, foam laminates, thermoformed articles, fibers, fabrics and automotive articles.

6. An article, having a skin layer thickness in a range of from 10 μm to 120 μm, formed from a copolymer comprising from 90 to 99.999 weight percent of propylene units, from 0.00 to 8 weight percent of olefin units other than propylene units, from 0.001 to 2.000 weight percent of α,ω-diene units, wherein the copolymer has a weight average molecular weight in a range from 50,000 to 2,000,000, a crystallization temperature in a range from 115° C. to 135° C. and a melt flow rate in a range from 0.1 dg/min to 100 dg/min.

7. The article of claim 6 wherein skin layer thickness is in a range from 30 μm to 100 μm.

8. The article of claim 6 further defined as an article selected from a group including films, fibers, fabrics, molded articles, injection molded articles, foamed articles and blow molded articles.

9. The article of claim 8 further defined as an article selected from a group including bottles, cast films, oriented films, injection molded articles, blow molded articles, foam laminates, thermoformed articles, fibers, fabrics and automotive articles.

10. The article of claim 6 wherein the olefin is selected from a group consisting of ethylene, C₃-C₁₀ α-olefins, diolefins and mixtures thereof.

11. The article of claim 6 wherein the olefin is selected from a group consisting of ethylene, butene-1, pentene-1, hexene-1, heptene-1, 4-methyl-1-pentene, 3-methyl-1-pentene, 4-methyl-1-hexene, 5-methyl-1-hexene, 1-octene, 1-decene, 1-undecene, and 1-dodecene.

12. The article of claim 6 wherein the crystallization temperature of the copolymer is in a range from greater than 115° C. to 130° C.

13. An article, having a skin layer thickness in a range of from 10 μm to 120 μm, formed from a copolymer comprising from 90 to 99.999 weight percent of propylene units, from 0.01 to 8 weight percent ethylene units, from 0.001 to 2.000 weight percent α,ω-diene units, wherein the copolymer has a weight average molecular weight in a range from 50,000 to 2,000,000, a crystallization temperature in a range from 115° C. to 135° C. and a melt flow rate in a range from 0.1 dg/min to 100 dg/min.

14. The article of claim 13 wherein the weight percent of α,ω-diene units present in the copolymer is from 0.005 to 1.5.

15. The article of claim 13 wherein skin layer thickness is in a range from 30 μm to 100 μm.

16. The article of claim 13 further defined as an article selected from a group including films, fibers, fabrics, molded articles, injection molded articles, foamed articles and blow molded articles.

17. The article of claim 16 further defined as an article selected from a group including bottles, cast films, oriented films, injection molded articles, blow molded articles, foam laminates, thermoformed articles, fibers, fabrics and automotive articles.

18. The article of claim 13 further including olefin units selected from a group consisting of ethylene, C₃-C₁₀ α-olefins, diolefins and mixtures thereof.

19. The article of claim 13 wherein the crystallization temperature of the copolymer is in a range from greater than 115° C. to 130° C.

20. The article of claim 13 wherein the copolymer is further defined as having at least two crystalline populations.

21. The article of claim 20 wherein the copolymer is further defined as having at least two crystalline populations wherein one of the crystalline populations has a first melting point in a first melting point range and another crystalline population has a second melting point in a second melting point range and wherein the first melting point range is distinguishable from the second melting point range by a temperature range of from 1° C. to 8° C.

22. The article of claim 21 wherein the copolymer is further defined as having one of the crystalline populations having a melting point in the range from 152° C. to 158° C. and another crystalline population having a melting point in the range from 142° C. to 148° C.
